(19) United States
(12) Patent Application Publication
(10) Pub. No.: US 2026/0369152 A1
(43) Pub. Date: Nov. 19, 2026

(54) Security Waf

(71) Applicant: Ramon Vladimir Rodriguez Delfin, MIAMI, FL (US)

(72) Inventor: Ramon Vladimir Rodriguez Delfin, MIAMI, FL (US)

(21) Appl. No.: 19/207,239

(22) Filed: May 13, 2025

(51) Int. Cl. G08B 21/08; H02J 7/35

(52) U.S. Cl. CPC G08B 21/084; H02J 7/35

(57) ABSTRACT

Security Waf is a safety system designed to monitor bodies of water, especially in residential environments such as swimming pools, in order to detect risk situations like the fall of children or pets. The system captures data on the dynamic behavior of the water surface and performs periodic self-calibration. It limits the analysis exclusively to variations occurring below the reference level, taking into account ripple, temperature, salinity, and other factors, significantly minimizing false alarms caused by floating objects and atmospheric phenomena. It can operate alongside base units or connect directly to mobile applications.

### BACKGROUND

Accidents caused by falls into bodies of water, especially in residential swimming pools, pose a significant risk to children, pets, and vulnerable individuals. In response to this problem, various safety systems have been developed to detect presence or movement on the water surface using conventional solutions. However, many of these systems present important technical limitations. They generate false alarms due to factors such as wind, rain, recirculation pumping, or the presence of floating objects, and they lack adaptive calibration mechanisms to distinguish between relevant events and minor disturbances. In addition, some of these systems require complex installations or rely on external infrastructure for operation. In many cases, this lack of precision leads to user frustration, resulting in the system being deactivated or discontinued. These limitations highlight the need for a safety system capable of continuous, precise, and autonomous monitoring, able to adapt to actual environmental conditions and detect only significant events, effectively reducing false alarms.

### SUMMARY

The invention consists of a security system designed to detect the significant fall of a body into the water, as may occur with a child, pet, or a person in a vulnerable situation in residential pools. The system aims to identify only real risk events, avoiding false alarms caused by minor disturbances or non-critical surface conditions.

To ensure this, the system includes an internal dynamic protocol that sets a predefined activation threshold, corresponding to a minimum trough that must be exceeded to consider an event critical. This threshold is automatically corrected through its periodic self-calibration.

During calibration, performed every 15 to 30 seconds, the system determines a dynamic reference level (zero level), defined as the midpoint between the crests and troughs generated by surface ripple, which coincides with the static level of calm water. In this process, the system also detects the ripple oscillation period, which depends on the water depth, and uses it to define the optimal analysis duration to capture one or more full cycles. If conditions are perfectly calm, the system operates initially with predefined period values stored in its internal protocol, until reliable signals allow updating those parameters.

From the zero level, the system discards all crests and focuses the analysis only on the lower values or troughs. This strategy avoids false alarms caused by surface disturbances such as floating objects, splashes, rain, recirculation pumping, or similar factors. It also records the deepest troughs of the ripple within the defined analysis period.

The maximum depth of these troughs is added to the predefined base activation threshold, thereby adjusting the system's sensitivity to match real environmental conditions.

In addition, the system measures the temperature and salinity of the aquatic medium, both of which affect the liquid's viscosity and, therefore, significantly influence wave amplitude. These parameters are used to dynamically correct the activation threshold.

This approach prevents small disturbances—normally below the threshold—from triggering false alerts when combined with ripple fluctuations, and also avoids missing critical events whose signal might be attenuated due to increased viscosity.

The system also supports multiple analyzers installed in the same body of water, coordinated to expand monitoring coverage and reduce detection delay. All analyzers operate under a unified base unit or control system.

Each unit is powered by a rechargeable battery, which can be recharged via solar cells or low-voltage cable connection. The system is capable of operating autonomously or in conjunction with a base unit, and can communicate directly with mobile applications or cloud platforms to transmit real-time values of liquid characteristics such as temperature, salinity, and pH.

### DESCRIPTION

The present description refers in detail to a security system designed to detect the significant fall of a body into water. In this application, its use in residential swimming pools is taken as an example, for the purpose of facilitating understanding.

FIG. 1 shows the positioning of the analyzer device in a pool installation, illustrating its location at the edge and its orientation toward the surface of the water. Two views are presented:

FIG. 1A (top view) shows a swimming pool (0.1) as the installation environment, including the perimeter edge (0.1.1). In this configuration, a single analyzer unit (1) is shown installed on the pool edge (0.1.1), oriented toward the body of water (0.1.3). The additional unit (1′) represents a second analytical unit, illustrating the possibility of installing multiple analyzers to improve monitoring coverage.

FIG. 1B (cross-section view) shows a cross-sectional view (0.1.2) of the pool (0.1), the perimeter edge (0.1.1), and the contained body of water (0.1.3). The analyzer (1) projects a beam (0.2) onto the surface of the water (0.1.4) for waveform analysis, and is capable of generating an acoustic alarm (0.5) and flashing red-and-blue light signals through its translucent body (1.3) in the event of imminent danger. It also emits a second beam (0.3) aimed at sensing the temperature of the aquatic medium (0.1.3) during periodic self-calibration.

FIG. 2 shows setup variants of the analyzer (1) installation system, illustrating different modes of operation and connectivity. FIG. 2A (cross-section view) represents a cross-sectional view (0.1.2) of the pool (0.1), the perimeter edge (0.1.1), and the contained body of water (0.1.3). The analyzer (1) projects a beam (0.2) onto the surface of the water (0.1.4) for waveform analysis, and is capable of generating an alarm (0.5) in the event of imminent danger. In this variant, the system is autonomous and relies solely on at least one analyzer (1).

FIG. 2B (cross-section view) shows the same environment configuration (0.1, 0.1.1, 0.1.3), with the difference that the system is composed of at least one analyzer (1) and a portable device (2), which interact remotely via RF, Wi-Fi, Bluetooth, etc.

FIG. 2C (cross-section view) maintains the same arrangement of pool and analyzer (1) elements, which in this case is connected to the cloud (0.3) and allows interaction with mobile phones and tablets (0.4) through an application.

Finally, FIG. 2D (cross-section view) presents the combination of both previous modes, where the analyzer (1) connects both to the cloud (0.3) and to the portable device (2), functioning jointly and integrated with mobile devices (0.4).

External view of the analyzer device, including two views that allow identification of its general configuration and the visible elements of the assembly.

FIG. 3A (top view) shows a top view of the analyzer (1), highlighting the solar cell (1.5) located at the top of the device, used to recharge the internal battery. The sensor housing (1.1) is also visible, protecting the components responsible for emitting and receiving signals for the analysis of the water surface.

FIG. 3B (side view) shows a side view of the analyzer (1), highlighting its external configuration and visible components. At the top of the device is the solar cell (1.5), used to recharge the internal battery. On one of its sides is the button panel (1.4), which consists of several buttons for functions such as power on/off, alarm activation or deactivation, and selection of water type (fresh or brackish), in configurations that do not use the external accessory (1.2). At the base of the device is the adhesive base (1.6), which allows secure attachment to the perimeter edge (0.1.1) of the pool, as shown in FIG. 1B. The body of the analyzer (1.3) is translucent, allowing visibility of the blue and red lighting in case of alarm activation.

At the bottom of the device is the sensor housing (1.1), which contains the surface analysis sensor (1.1.1) and the laser temperature sensor (1.1.2), used when the external accessory (1.2) is not connected. The external accessory (1.2) connects to the device via the connector (1.2.3) and includes at its end a sensor head (1.2.1) to directly measure environmental parameters such as temperature, salinity, and pH, connected through a flexible cable (1.2.2).

FIG. 4A (front view) shows a front view of the portable station device (2), which can function as a base station or remote interaction unit. The following components are visible: the button panel (2.1), which includes the stop button (2.1.1) and other buttons for functions such as power on, power off, or water type selection; an external antenna (2.2.3) to improve wireless connectivity; a translucent casing (2.4) that allows visualization of light signals during alarm activation; a power socket (0.6) to keep the device powered; and the external casing (2.5), which protects the entire unit.

FIG. 4B (side view) shows a side view of the same device (2), again highlighting the external antenna (2.2.3), the stop button (2.1.1), the translucent casing (2.4), and the external casing (2.5), with a possible foldable prong for electrical connection (2.6).

FIG. 5 represents the process of periodic automatic calibration of the system, focused on the analysis surface (0.1.4) of the pool (see FIG. 1B).

FIG. 5A shows the characteristic ripple pattern caused by factors such as wind, rain, or recirculation pumping.

FIG. 5B illustrates how the system identifies the reference level (zero level) based on the crests and troughs of the ripple.

FIG. 5C shows the removal of the crests, retaining only the deepest depression as the ripple level (LR), which is stored in memory and later compared to the preset threshold (LT). This comparison allows the establishment of a calibrated reference baseline. This technique prevents surface crests caused by floating objects or minor events from triggering unnecessary false alarms. FIG. 6 shows the analysis of a perturbation and how it is compensated using the values obtained during the previous calibration.

FIG. 6A represents an isolated perturbation, shown as a dotted line, over the surface of the water (0.1.4) of the pool (see FIG. 1B).

FIG. 6B shows the same perturbation without its crest, identifying the perturbation level (LP) and the lower threshold baseline reference for triggering (LT), which is not exceeded in this case.

FIG. 6C represents the ripple pattern stored in memory, which does not reach the threshold (LT).

FIG. 6D shows the sum of the ripple and the perturbation, generating a combined value (LS=LR+LP), which does not exceed the compensated threshold (LT2), avoiding a false alarm.

Finally, FIG. 6E shows the case in which, without such compensation, the same combination could trigger a false alarm by exceeding the original threshold (LT).

FIG. 7 represents a block diagram of the analyzer device (1), detailing its main electronic modules and their interconnection.

The Main Module (1.2) constitutes the processing core of the system. It is composed of a processor (1.2.1), responsible for executing the device's functions; a communication circuit (1.2.2); and its corresponding antenna (1.2.3), through which data is exchanged with external devices such as the portable station.

The Sensor Module (1.1) receives and transmits data to the processor (1.2.1). This module incorporates a distance sensor (1.1.1), used to analyze oscillations on the water surface (0.1.4) through a measurement beam (0.2), and a temperature sensor (1.1.2), which senses the temperature of the aquatic medium (0.1.3) via a second beam (0.3), as part of the self-calibration process.

The system also includes an Alarm Module (1.5), which receives signals from the processor (1.2.1) in the event of a critical detection. This module includes an amplifier (1.5.1), a speaker (1.5.3) to emit the acoustic alarm, and an RGB LED (1.5.2) that generates a flashing visual signal in red and blue colors.

The user interface consists of the Button Panel (1.4), which includes a Stop Button (1.4.1), a Switch Button (1.4.2), and a generic Button A (1.4.3), all connected to the processor to activate or modify system functions.

Power supply is managed through the Power Supply Module (1.3), which receives charge from a photovoltaic cell (1.5). This module includes a charging circuit (1.3.2) and a rechargeable battery (1.3.3), allowing the analyzer to operate autonomously even without an external connection. FIG. 8 represents a block diagram of the portable station device (2), showing its main internal modules and the functional relationship between them.

The system includes a Button Panel (2.1) composed of a Stop Button (2.1.1), a Switch Button, and a generic Button A, which allow interaction with the system processor and execution of functions such as power on, power off, or parameter modification according to the selected configuration.

Data processing is centralized in the Main Module (2.2), which includes a processor (2.2.1) responsible for the device's internal operations, as well as a Communication Board (2.2.2) with its external antenna (2.2.3), through which data is exchanged with the analyzer or with external services.

The alert system consists of an Alarm Module (2.3) that receives signals from the processor (2.2.1) when a critical condition is detected. This module includes an amplifier (2.3.1), a speaker (2.3.3) to emit an acoustic alarm, and an RGB LED (2.3.2) responsible for generating a flashing visual signal in red and blue colors.

Power supply is managed through the Power Supply Module (2.4), which receives energy from an external source through an AC-DC circuit (2.4.1). This module also includes a charging circuit (2.4.2) and a rechargeable battery (2.4.3), allowing the system to remain functional even during power outages.

### BRIEF DESCRIPTION OF THE DRAWINGS

FIG. 1. Analyzer positioning in pool installation, including a top view and a cross-sectional view showing the device mounted at the edge and oriented toward the water surface.

FIG. 2. System setup variants illustrating alternative configurations of the analyzer.

FIG. 2A. Analyzer operating autonomously.

FIG. 2B. Analyzer connected to a portable base unit.

FIG. 2C. Analyzer connected to a cloud platform for mobile applications.

FIG. 2D. Analyzer integrated with a portable base unit and simultaneously connected to a cloud platform for mobile applications.

FIG. 3. Wave analyzer device showing general structure and external casing.

FIG. 3A. Top view of the device.

FIG. 3B. Side view of the device.

FIG. 4. Portable station device showing external structure and general configuration.

FIG. 4A. Front view of the portable station device.

FIG. 4B. Side view of the portable station device.

FIG. 5. Periodic automatic calibration process used to adjust detection thresholds based on wave behavior.

FIG. 5A. Ripple pattern observed on the surface of the liquid.

FIG. 5B. Identification of the reference level corresponding to a state of absolute rest.

FIG. 5C. Crest removal from the surface signal.

FIG. 6. Wave perturbation analysis showing the interaction between perturbation and ripple relative to the internal threshold pattern.

FIG. 6A. Isolated waveform of a minor perturbation.

FIG. 6B. Trough of a minor perturbation below activation threshold.

FIG. 6C. Ripple trough recorded during calibration process.

FIG. 6D. Compensated waveform showing combined ripple and perturbation remaining below the internal threshold.

FIG. 6E. Uncompensated waveform causing a false alert due to ripple perturbation summation exceeding the internal threshold.

FIG. 7. Block diagram of the wave analyzer device, including the main electronic modules and their internal interconnections.

FIG. 8. Block diagram of the portable station, including the main electronic modules and their internal interconnections.

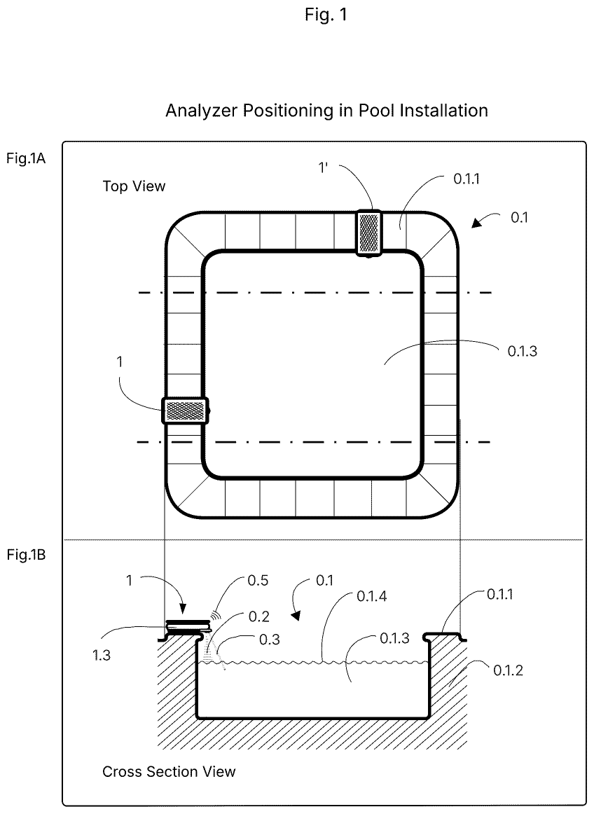

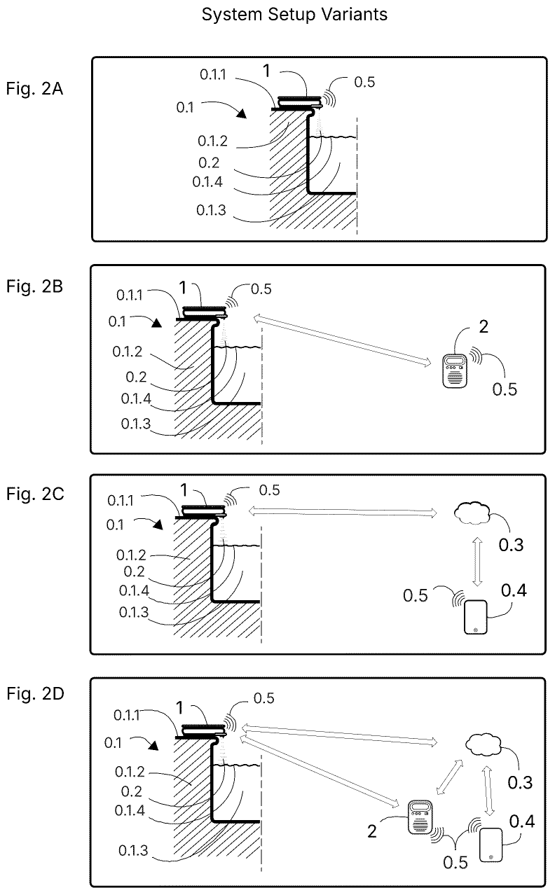

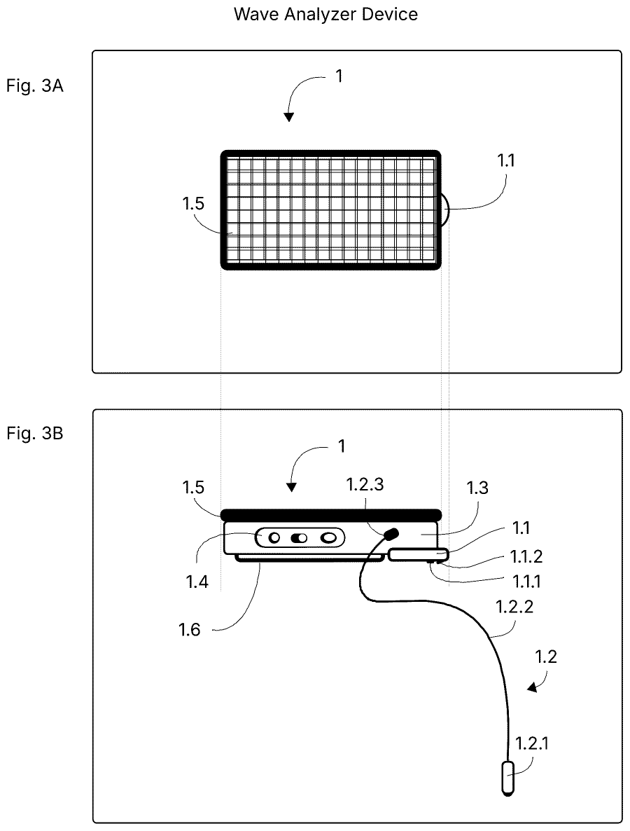

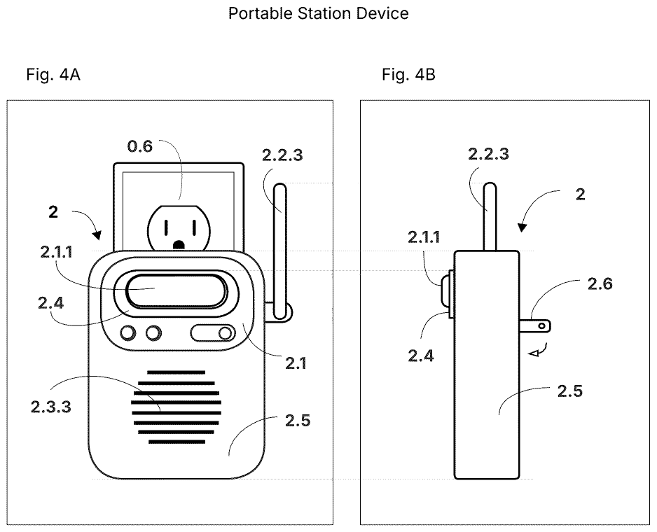

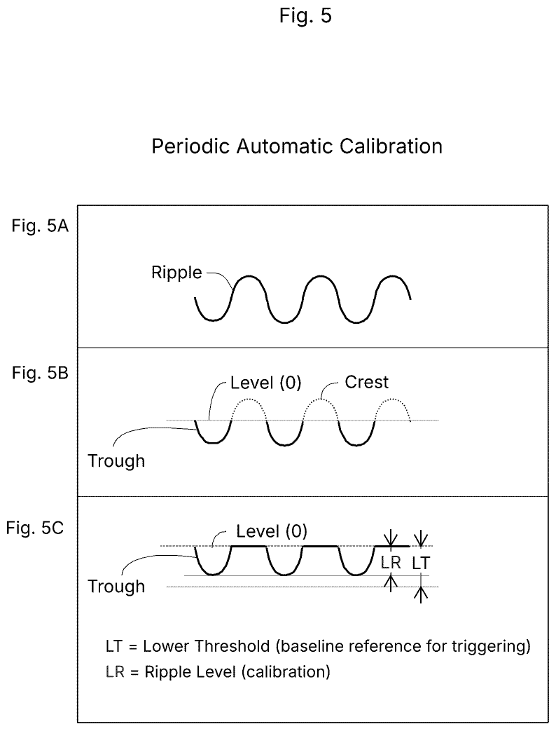

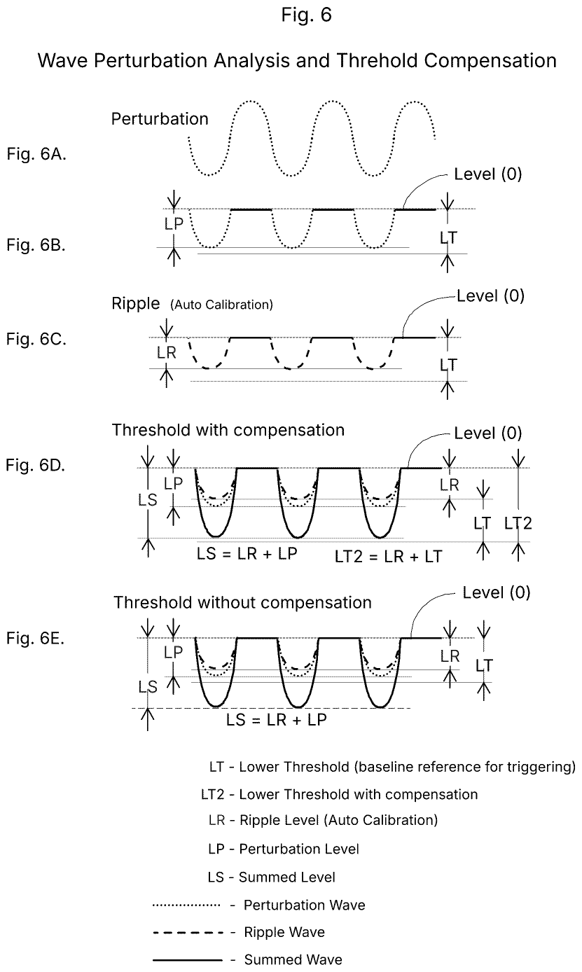

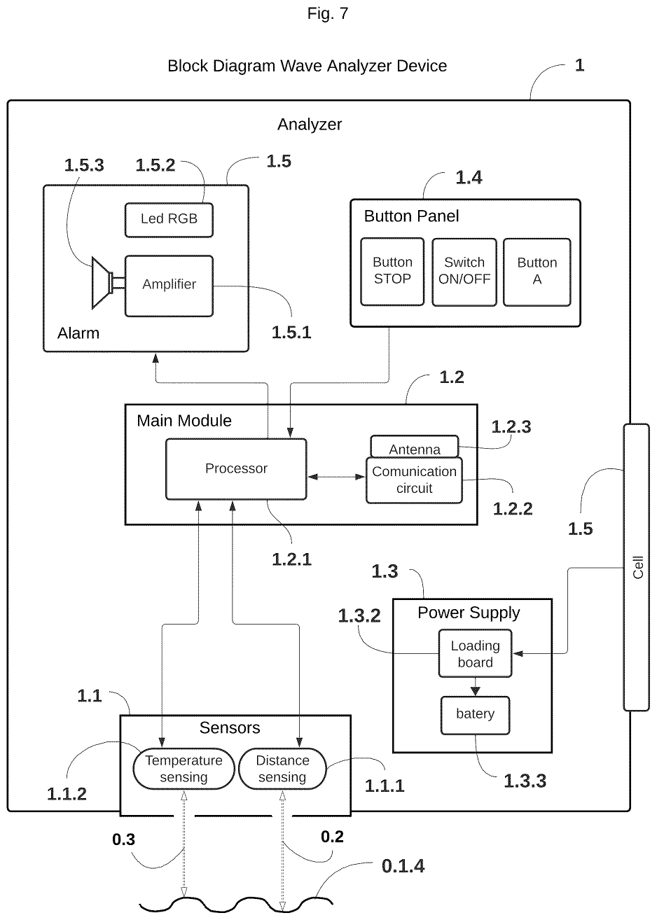

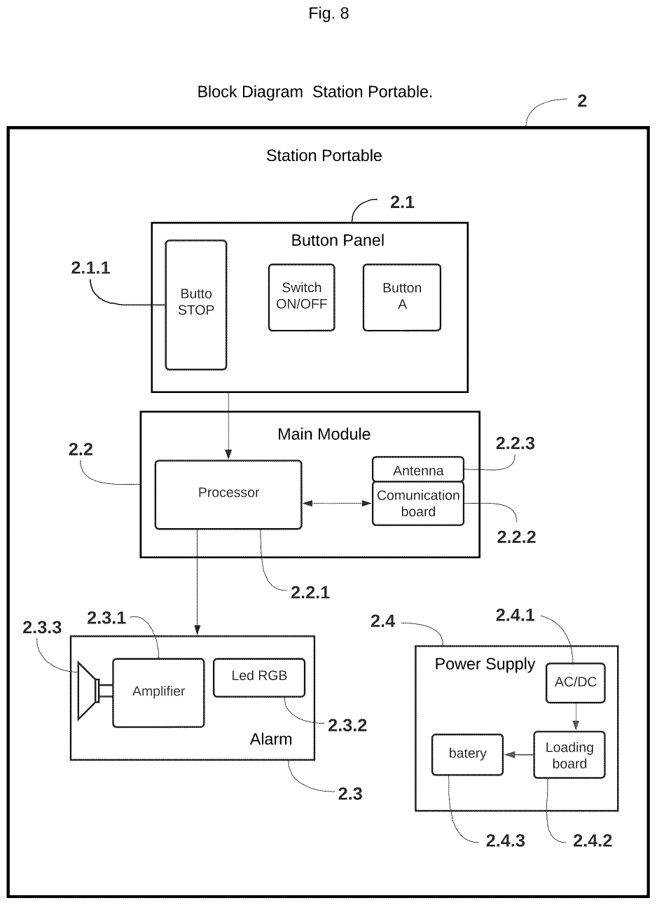

1-6. (canceled)

7. A safety system for monitoring a body of water, comprising:
an analytical unit located in proximity to the body of water, the analytical unit comprising a distance sensor, at least one processor, and an alarm module configured to generate a visual and acoustic alarm;
the distance sensor being configured to direct a measurement beam toward a surface of the body of water and to generate measurement sequences comprising measured distances between the distance sensor and the surface; and
the at least one processor being configured to:
perform an initial calibration and periodic calibrations using the measurement sequences to establish and update a reference distance representing a zero level of the surface relative to the distance sensor;
establish an activation threshold representing a predetermined increase in measured distance relative to the updated reference distance;
during an alarm-detection analysis, identify, from the measurement sequences obtained during a monitoring analysis period, crest measurements having measured distances less than the updated reference distance and trough measurements having measured distances greater than the updated reference distance;
exclude the crest measurements from the alarm-detection analysis;
select, from the trough measurements, a relevant trough measurement having a greatest measured distance during the monitoring analysis period;
determine a trough depth by calculating a difference between the greatest measured distance and the updated reference distance; and
cause the alarm module to generate the visual and acoustic alarm only when the trough depth exceeds the activation threshold.

8. The system of claim 7, further comprising a temperature sensor and a salinity sensor configured to measure temperature and salinity, respectively, of the body of water, wherein the at least one processor is configured to apply a correction to the activation threshold based on the measured temperature and salinity.

9. The system of claim 7, further comprising a communication circuit configured to communicate with a cloud platform and to enable remote interaction with the system through a mobile application.
